(19) United States
(12) Patent Application Publication
(10) Pub. No.: US 2013/0103791 A1
(43) Pub. Date: Apr. 25, 2013

(54) Optimizing content delivery over a protocol that enables request multiplexing and flow control

(71) Applicants: Yair Gottdenker, Tel Aviv (IL); Udi Trugman, Alfe-Menashe (IL); Ido Safruti, San Francisco, CA (US)

(72) Inventors: Yair Gottdenker, Tel Aviv (IL); Udi Trugman, Alfe-Menashe (IL); Ido Safruti, San Francisco, CA (US)

(73) Assignee: COTENDO, INC., Cambridge, MA (US)

(21) Appl. No.: 13/476,132

(22) Filed: May 21, 2012

Related U.S. Application Data
(60) Provisional application No. 61/488,146, filed on May 19, 2011.

(51) Int. Cl. H04L 29/08

(52) U.S. Cl. CPC H04L 67/02
USPC 709/217

(57) ABSTRACT

A content delivery network (CDN) proxy (or, more generally, a server) that is content-aware is programmed to modify or augment a content object in such a manner that the content object, or elements thereof, is or are deliverable to a requesting client over a multi-stream, priority-enable connection. A representative application layer protocol that implements such delivery is SPDY. By virtue of its content-awareness, one or more elements of the content object may be delivered with prioritization so as to optimize “effective” page load time, namely, the time necessary for usable portions of the page to be loaded and rendered on the requesting client.

This application is based on and claims priority to U.S. Ser. No. 61/488,146, filed May 19, 2011.

### TECHNICAL FIELD

This disclosure relates generally to content delivery over a network.

### BACKGROUND OF THE RELATED ART

HTTP is a common protocol widely used in the World Wide Web to deliver data, web sites, applications, APIs and more. It has become one of the most popular protocols over the internet. HTTP version 1.1 was finalized in June 1999, and it is described in Internet RFC 2616. Needless to say, in the last 12 years, there have been significant changes and evolution in the Internet itself, in server and computer hardware and capabilities (e.g., CPU power, storage, and memory), in server software, in the widespread adoption and use of new client devices, operating systems, browsers, methods of connection, and more. Thus, the client-server eco-system is rapidly evolving and changing.

HTTP is a synchronous protocol, enabling only one request to be carried on a given HTTP connection. It also is a protocol which is request driven, so that server can send only the data that was requested; in other words, the server cannot push data to the client, even if the server “knows” that this data will be soon requested by the client. A detailed explanation on some of the inefficiencies and limitations of the HTTP protocol are described in the following whitepaper, which called for the creation of the SPDY protocol and the objectives for it: www.chromium.org/spdy/spdy-whitepaper. The SPDY protocol is one of many suggestions to enhance HTTP to overcome some of these issues. It is an application-layer protocol for transporting content over the web, and it is designed specifically for minimal latency. Generally, the protocol works by adding a session layer on top of a presentation layer (e.g., SSL) that allows for multiple concurrent, interleaved streams over a single TCP connection. Because requests are interleaved on a single channel, the efficiency of the underlying transport protocol (TCP) is much higher. SPDY also implements request priorities: the client can request as many items as it wants from the server, and assign a priority to each request. This prevents the network channel from being congested with non-critical resources when a high priority request is pending. SPDY also compresses request and response HTTP headers, which results in fewer packets and fewer bytes transmitted. SDPY assumes the existence of a SPDY-enabled browser, as well as appropriate server-side support.

A well-known distributed computer system is a “content delivery network” (or “CDN”) that is operated and managed by a service provider. The service provider provides a content delivery service on behalf of third parties using its CDN. A “distributed system” of this type typically refers to a collection of autonomous computers linked by a network or networks, together with the software, systems, protocols and techniques designed to facilitate various services, such as content delivery or the support of outsourced site infrastructure. Typically, “content delivery” means the storage, caching, or transmission of content, streaming media and applications on behalf of content providers, including ancillary technologies used therewith including, without limitation, DNS query handling, provisioning, data monitoring and reporting, content targeting, personalization, and business intelligence.

### BRIEF SUMMARY

A content delivery network is enhanced to take advantage of application layer protocols, such as SPDY, that provide multiplexing and flow control of requests from enabled clients. According to this disclosure, particular content (or a content type) or other data to be delivered from the CDN is delivered over one or more client-server connections using a multi-stream protocol (such as SPDY) to optimize delivery and enable faster load time.

The foregoing has outlined some of the more pertinent features of the subject matter. These features should be construed to be merely illustrative.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 is an exemplary infrastructure for a content delivery service;

FIG. 2 illustrates a representative edge server machine in the CDN of FIG. 1;

FIG. 3 illustrates a first example of delivery of an HTML page from a proxy according to the technique described herein;

FIG. 4 illustrates a second example of delivery of an HTML page from the proxy; and

FIG. 5 illustrates a multiplexed stream of data illustrating how various object portions are delivered out of order and on a prioritized basis to improve performance.

### DETAILED DESCRIPTION

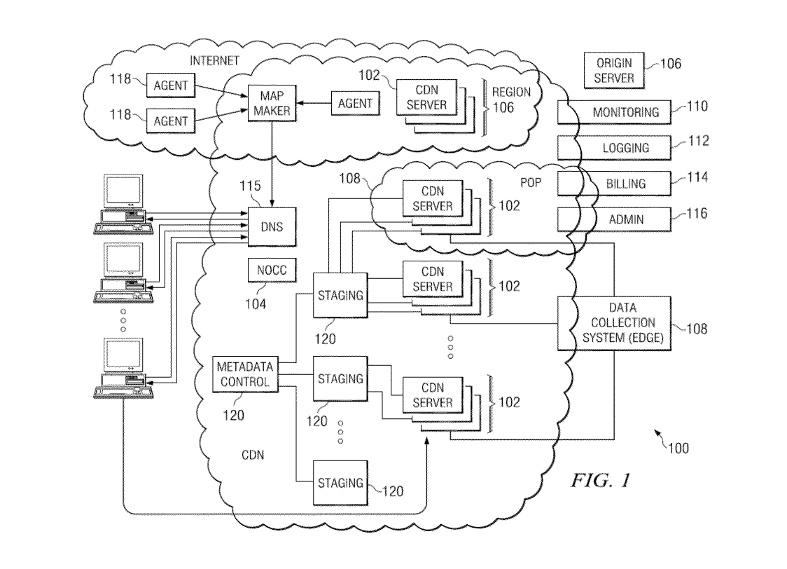

In a known system, such as shown in FIG. 1, a distributed computer system 100 is configured as a CDN and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to “edge” servers. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

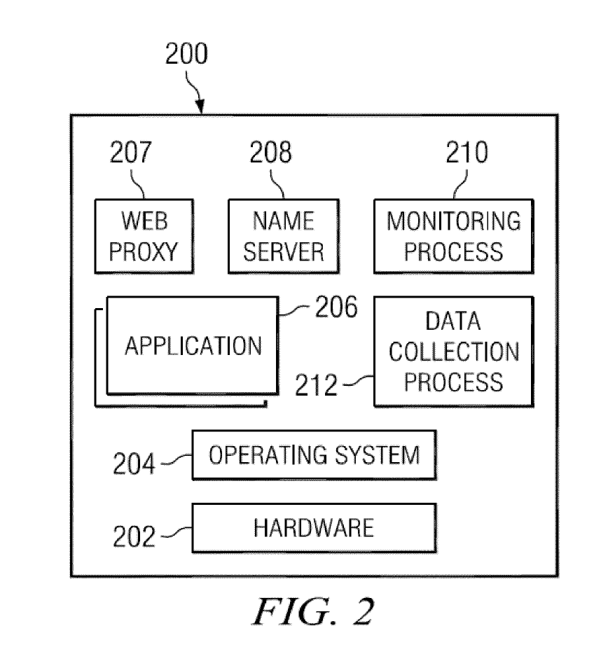

As illustrated in FIG. 2, a given machine 200 comprises commodity single core or multi-core hardware 202 running an operating system kernel (such as Linux™ or variant) 204 that supports one or more applications 206a-n. To facilitate content delivery services, for example, given machines typically run a set of applications, such as an HTTP proxy 207 (sometimes referred to as a “global host” or “ghost” process), a name server 208, a local monitoring process 210, a distributed data collection process 212, and the like. More generally, ghost is software, comprising program instructions, which instructions are held in memory and executed by a processor as needed. For streaming media, the machine may include one or more media servers, such as a Windows® Media Server (WMS) or Adobe® Flash® server, as required by the supported media formats.

A CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features. The configuration file may be delivered to the CDN edge server via the data transport mechanism. U.S. Pat. No. 7,111,057 illustrates a useful infrastructure for delivering and managing edge server content control information, and this and other edge server control information can be provisioned by the CDN service provider itself, or (via an extranet or the like) the content provider customer who operates the origin server. U.S. Pat. No. 7,240,100 describes a technique for applying the content handling rules and directives to specific content requests.

The CDN may include a storage subsystem, such as described in U.S. Pat. No. 7,472,178, the disclosure of which is incorporated herein by reference.

The CDN may operate a server cache hierarchy to provide intermediate caching of customer content; one such cache hierarchy subsystem is described in U.S. Pat. No. 7,376,716, the disclosure of which is incorporated herein by reference.

The CDN may provide secure content delivery among a client browser, edge server and customer origin server in the manner described in U.S. Publication No. 20040093419. Secure content delivery as described therein enforces SSL-based links between the client and the edge server process, on the one hand, and between the edge server process and an origin server process, on the other hand. This enables an SSL-protected web page and/or components thereof to be delivered via the edge server.

Because the CDN infrastructure is shared by multiple third parties, it is sometimes referred to herein as a multi-tenant shared infrastructure. The CDN processes may be located at nodes that are publicly-routable on the Internet, within or adjacent nodes that are located in mobile networks, in or adjacent enterprise-based private networks, or in any combination thereof.

As an overlay, the CDN resources also may be used to facilitate wide area network (WAN) acceleration services between enterprise data centers (which may be privately-managed) and third party software-as-a-service (SaaS) providers.

In general, a client communicates with a CDN edge machine and makes requests for content, such as web sites, web pages, web applications, web page resources, and the like. A client is a conventional desktop, laptop or other Internet-accessible machine running a web browser or other rendering engine. The client may also be a mobile device. As used herein, a mobile device is any wireless client device, e.g., a cellphone, pager, a personal digital assistant (PDA, e.g., with GPRS NIC), a mobile computer with a smartphone client, or the like. Other mobile devices in which the technique may be practiced include any access protocol-enabled device (e.g., iOS™-based device, an Android™-based device, or the like) that is capable of sending and receiving data in a wireless manner using a wireless protocol. Typical wireless protocols are: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. In a representative embodiment, the mobile device is a cellular telephone that operates over GPRS (General Packet Radio Service), which is a data technology for GSM networks. Generalizing, a mobile device as used herein is a 3G—(or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards.

According to this disclosure, the client browser is assumed to be enabled to support a protocol that enables multiplexing and flow control of requests. Thus, in a representative embodiment, a client browser and an associated edge server machine is enabled to provide support for a protocol, such as SPDY, that enables multiple streams to flow over a single connection. This protocol enables multiplexing of several requests/responses on the same connection, as well as the prioritizing of these requests/responses.

### An Embodiment

### Progressive Image Delivery

With the above as background, the subject matter of this disclosure is now described using a specific, but non-limiting example.

A web page is assumed to contain N images. It is further assumed these images are JPEG images (images formatted in the JPEG format). A CDN such as described above is delivering the content for the web server, so the system is such that a client contacts a proxy server for the delivery of the content, and the proxy server serves the content from cache if the content is cached, or it will fetch it from an origin and serve it to the requesting user. This is the usual client-server interaction for a CDN proxy. The proxy server can also generate new content or modify content in delivery, based on some cached or retrieved content.

Assume now that the images within that page were requested by a user and so were retrieved from the origin (in order to serve them), and are then stored in cache associated with the proxy. Before storing those images, and according to this disclosure, the proxy re-renders each JPEG image to create a progressive JPEG (see //en.wikipedia.org/wiki/JPEG) instead of the original one. In this case, for simplicity, assume that each progressive JPEG consists of 2 qualities: 30% and 100%. Now, assume that a user with low bandwidth throughput (for instance connecting through a congested mobile network) initiates a SPDY request to this web page. The proxy serves this page to the user (either from cache or after receiving it from the origin). Once the client on the user's side receives that webpage, it then generates N requests to the N images linked/referred in the HTML file (in the usual manner). The proxy at that point then utilizes the multiplexing capability of the SPDY protocol, preferably in the following manner. Instead of transmitting the images fully each after the other (which might cause the images to be delivered in sequential order over SPDY), the proxy sends the first sections of each progressive image (the section corresponding to the lower quality part, which is typically much smaller than the full file). In other words, for example, the proxy sends the lower quality layers of the N images and, then, as those lower quality image layers are being rendered, the proxy sends higher quality layers of the N images. Thus, in this (non-limiting) example, the proxy uses the SPDY protocol to multiplex between the N images in sending first the lower quality layers for the N images, and then followed by the higher quality layers for the N images. Moreover, the web page in this example might also have additional (non-image) objects, and (in such case) the proxy may also use the SPDY protocol to multiplex between those objects, e.g., to send all of those objects before sending the higher quality layers of the N images. Thus, for example, the higher quality layers of the N images would be sent after those additional objects had already been sent and were being rendered. After the proxy writes the low quality parts of the progressive images to the HTTP connection send buffer, the proxy waits with the delivery of the remaining part of the images until the other elements of the page are sent. Only when all the elements of the page which are important for the page (either all elements, or the elements that are required for the user to interact with the page, or any other decision that is relevant for that site), the proxy can continue and deliver the remainder of the images (to ensure the full quality of the image is eventually received and rendered at the client browser).

This technique provides a better user experience, as the user receives (relatively fast) the low quality portion of the images, which is enough to understand the page and for the page to render correctly; thus, the web page would be fully usable faster. The higher quality parts of each image are then downloaded fully in the background. This is achieved as typically browsers render images as they are received, and not merely on completion.

As the higher quality layers are delivered over the same original image request (simply or in effect a continuation of the delivered object)—no additional request is required from the client.

While the above is merely a representative example, a person skilled in the art will appreciate that the technique may be used for other types of CDN delivered content. The SPDY capability that enables such an optimization (that is not available with standard HTTP) is that SPDY enables multiplexing, and further that it enables the response to a particular request to be delayed without blocking the entire connection or otherwise reducing performance with respect to other requests on the connection. This enables the proxy to control the transmitted data to the user, including the order of delivery of the different objects, as well as splitting the delivery of an object (such as the images) and appending the additional data with no need from the user/browser to request the additional data. This technique also avoids the overhead requiring the proxy to store several qualities of an object and delivering it in several different requests. In the context of a CDN, the approach saves storage space and lookup space, and it enables more efficient object management. It also simplifies the delivery of the content while enabling a faster more responsive site.

The above-described embodiment may be implemented on the origin server to optimize delivery of the content, or it can be implemented on a CDN (as described), to offer it as a service that optimizes delivery and enables faster loading pages.

This technique may be implemented to optimize delivery of other types of data/content, and not only images within web pages. In particular, any data that is compound of multiple elements, delivered over a network, where certain elements can have an initial portion that is sufficient for the initial interaction, or to start the task that is required by the receiving side, may be managed over such a multi-stream, priority-enabling connection to optimize delivery and enable faster load time. The approach provides an optimization to protocols such as SPDY, which are not content-aware.

Using this approach, a CDN proxy (or, more generally, a server) that is content-aware is programmed to modify or augment a content object in such a manner that the content object, or elements thereof, is or are deliverable to a requesting client over a multi-stream, priority-enable connection. By virtue of its content-awareness, one or more elements of the content object may be delivered with prioritization so as to optimize “effective” page load time, namely, the time necessary for usable portions of the page to be loaded and rendered on the requesting client. Moreover, due to the content awareness, the CDN proxy may modify the content to make it more appropriate for different delivery types, or it may enable reprioritization of objects while delivered. Thus, the content awareness of the CDN server may take into consideration one or more factors, such as: the device type issuing the connection, the network conditions, the specific delivered object (image, video, script, or other, as described above), or the entire connection. Thus, for example, in the case of a standard web page (often consisting of tens of different elements including many scripts), analysis of the HTML page and the delivered scripts may determine that the server can optimize delivery of the page as a whole by reprioritizing and adjusting the delivered content.

Thus, the technique disclosed herein may be used for any type of content, content type, or other data delivered from a server.

The HTTP proxy includes code to generate one or more content elements of a particular content object, preferably according to a configuration rule or policy. A particular configuration rule may be applied to the content object (or a content object type). The content elements may be generated at the HTTP proxy, or they may be received from the origin, or from some other source.

The particular prioritization enforced by the HTTP proxy may be varied depending on the connection characteristics, or the characteristics of the client device. Thus, the techniques described herein may interoperate with other functions, such as client device detection and redirection, bandwidth detection and throttling, and the like.

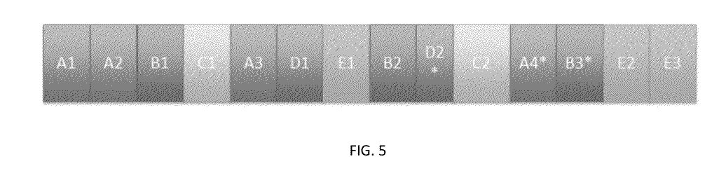

As another example, the delivery of an HTML object may be enhanced using the reprioritization techniques described. As a request for a new page arrives, the edge server typically does not have the required page and needs to retrieve it from the origin. In many cases, the responses for dynamic URLs will have a similar structure and requirement. In such cases, the edge server can guess the header of the HTML page (e.g., based on previously served such pages) and send it over to the client on a high priority. This enables the client to begin requesting the linked resources in the header of the page, which are typically already cached on the edge server. Because the linked resources typically get a high priority, the conventional approach may stall the delivery of the rest of the HTML until the actual page is actually retrieved from the origin server. Using the described approach, once the HTML page arrives at the edge server (from the origin) and is analyzed, the edge server can adjust the HTML content to comply with the portion that was already delivered; the rest of the page can then be delivered to the requesting client on a high priority. This approach is illustrated in FIG. 4. The result will be better performance for the page as a whole when considered from the client perspective.

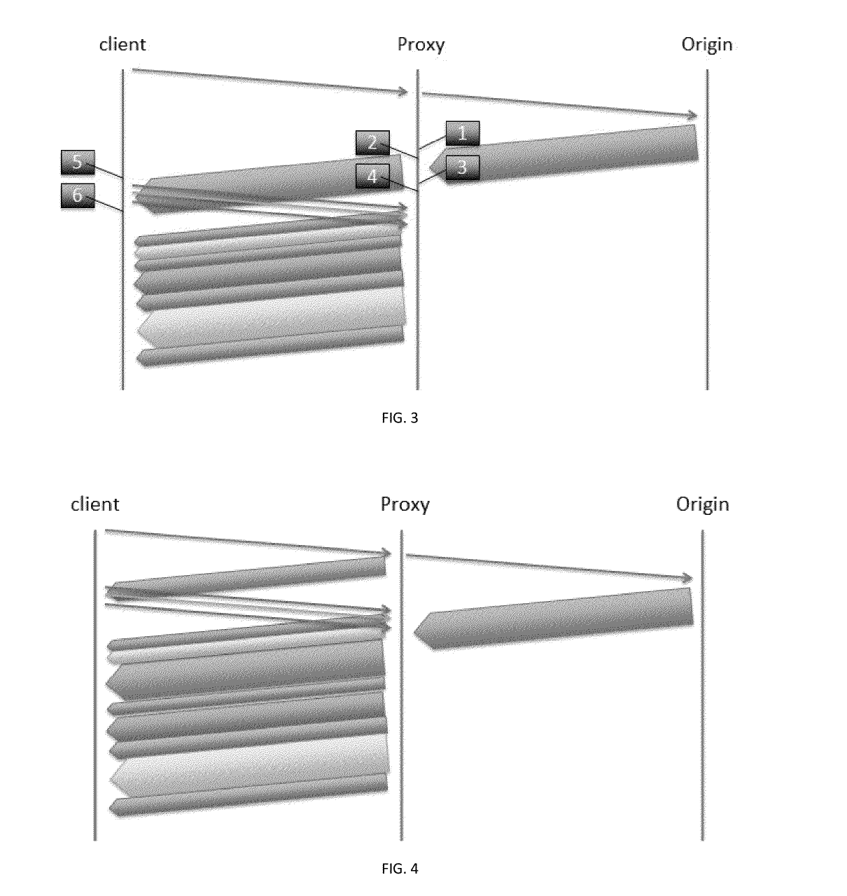

FIG. 3 illustrates the multiplexing of requests in an environment with a client, proxy, and origin server. This drawing captures the order of the requests, as well as the time to deliver a response. Initially, a request is sent from a client to the proxy. As the response to this request is not stored on the proxy, the proxy issues a request to the origin to get this object. The origin generates the page (this may take some time, hence the gap in time between request to response). The width of the response arrow from the origin illustrates the fact that a request processing can be long, in the sense that there is a start and end time to send the response, and a start and end time to receive a response. Requests typically are shorter in nature and illustrated here as thin arrows, although this is not a limitation. The numbers 1-6 point to times on the time axis when a response was received. The number 1 marks the first byte received by the proxy, while the number 2 marks the first byte sent by the proxy. The number 3 marks the last byte received by the proxy, and the number 4 the last byte sent. The numbers 5 and 6 similarly indicate the receive times at the client. In this illustration, it can be seen that the proxy may start sending data to the client before the response from the origin is completed. The client may also start receiving a response before the proxy completed sending it. The additional arrows illustrate three (3) requests to three different objects (most commonly, embedded objects linked within the HTML received on the first response). Note that these latter requests are “fired” before the HTML response is completely delivered. In traditional HTTP, the responses would be sent serially based on the order they were requested. In this illustration, in contrast, the proxy multiplexes chunks of the responses, sending initially a small portion of each requested object, and only then adding the rest of the objects.

FIG. 4 illustrates another multiplexing option as a variation on the previous example. In this case, the header of the HTML is delivered immediately by the proxy before receiving the actual file from the origin. This enables the client to fire the requests to the linked objects sooner; the server can then start serving the cached objects. Then, as soon as the response from the origin arrives, the proxy prioritizes the remainder of the HTML page and serves it; only then will it continue serving the other objects.

FIG. 5 illustrates a multiplexed stream of data. Each object is marked with a different letter. Objects are divided into frames and delivered along the stream. The blocks represent frames as delivered on the stream, and the number next to the letter marks the number of the frame. An asterisk marks the last frame of an object (indicating that this object is completed). Frames do not need to be in the same size (as illustrated in frames D2* and C2).

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A given implementation of the disclosed subject matter is software written in a given programming language that runs in conjunction with a proxy on a standard hardware platform running an operating system such as Linux. The functionality may be built into the proxy code, or it may be executed as an adjunct to that code. A machine implementing the techniques herein comprises a processor, computer memory holding instructions that are executed by the processor to perform the above-described methods, functions or operations.

While given components of the system have been described separately, one of ordinary skill will appreciate that some of the functions may be combined or shared in given instructions, program sequences, code portions, and the like.

Having described our invention, what we now claim is as follows:

1. Computing apparatus for an edge network, comprising:
processor hardware; and
an HTTP proxy executed by the processor hardware and including support for an application layer protocol that enables request multiplexing and flow control over a single connection, the HTTP proxy further including code that is responsive to a request for a content object for selectively delivering one or more elements of the content object via the application layer protocol.

2. The computing apparatus as described in claim 1 wherein the application layer protocol is SPDY.

3. The computing apparatus as described in claim 1 wherein the application layer protocol prioritizes delivery of at least a first element of the content object over at least a second element of the content object.

4. The computing apparatus as described in claim 1 wherein the content object is a JPEG image and the one or more elements of the JPEG image comprise one or more versions of the JPEG image of varying image quality.

5. The computing apparatus as described in claim 1 further including a cache in which the content object and the one or more elements are stored according to a caching rule.

6. The computing apparatus as described in claim 1 further including code to generate the one or more elements of the content object according to a configuration rule.

7. The computing apparatus as described in claim 1 wherein the content object is an HTML page.

8. Computing apparatus for an edge network, comprising:
processor hardware; and
an HTTP proxy executed by the processor hardware and including support for an application layer protocol that enables request multiplexing and flow control over a single connection, the HTTP proxy operative, with respect to a content object being managed by the edge network, to respond to multiple requests over the single connection out of order that the requests are received by the HTTP proxy.

9. The computing apparatus as described in claim 8 wherein the application layer protocol is SPDY.
